(19) United States
(12) Patent Application Publication
(10) Pub. No.: US 2011/0246277 A1
(43) Pub. Date: Oct. 6, 2011

(54) MULTI-FACTOR PROMOTIONAL OFFER SUGGESTION

(75) Inventors: Venkatesh Basappa Neldurg, Bangalore (IN); Ayaz Nabi, Bangalore (IN); Ben Ross, San Francisco, CA (US); Abhijit S. Bose, Bangalore (IN); Manoj K, Bangalore (IN); Manish Kumar, Bangalore (IN); Himanshu Gupta, Bangalore (IN); Manish R. Shah, Mountain View, CA (US); Bala Dutt, Bangalore (IN); Harsha K. Navada, Bangalore (IN)

(73) Assignee: INTUIT INC., Mountain View, CA (US)

(21) Appl. No.: 12/750,633

(22) Filed: Mar. 30, 2010

(51) Int. Cl. G06Q 30/00; G06Q 10/00

(52) U.S. Cl. 705/14.25; 705/14.36; 705/14.42; 705/14.52; 705/14.53

(57) ABSTRACT

The invention relates to a method to send a promotional offer from a business entity. The method steps include obtaining a profile of the business entity from a financial management application (FMA) executing on a central processing unit (CPU) and configured to manage operations of the business entity, analyzing a plurality of messages from a message source based on a pre-determined criterion to identify a keyword, qualifying the keyword to generate a qualified keyword with a keyword rating, wherein the keyword rating represents how relevant the keyword is to the business entity based on the profile of the business entity, searching for the qualified keyword in the promotional offer among a plurality of promotional offers in a library to generate a match between the qualified keyword and the promotional offer, adjusting a score of the promotional offer, in response to generating the match, based on the keyword rating, and sending the promotional offer to a consumer based on the score.

### BACKGROUND

Small business owners often rely on promotional offers to stimulate sales of a product or service, which typically have short term effects and need to be conducted on a regular basis. Examples of such promotional offers may include discount terms, coupons, sweepstakes, contests, product samples, rebates, tie-ins, trade-ins, etc. Promotional offers may be conducted in a direct marketing approach by sending messages (e.g., direct mail, e-mail, telemarketing message, text message such as Simple Message Service (SMS) message, instant messaging (IM) message, etc.) directly to consumers, which may be unsolicited. Promotional offers often involve an emphasis on traceable, measurable responses from consumers and are sometimes designed around a particular event related to the nature of the business.

A message crawler is a computer program that browses the world wide web in a methodical, automated manner. Message crawlers are mainly used to create a copy of all the visited web pages for later processing by a search engine that will index the downloaded pages to provide fast searches. Message crawlers can also be used to gather specific types of information from web pages, such as harvesting e-mail addresses, which may be used for unsolicited email SPAM.

RSS (i.e., “Really Simple Syndication” or “Rich Site Summary”) is a family of message feed formats used to publish frequently updated information, such as blog entries, news headlines, audio, video, etc. A RSS document is referred to as “feed”, “Message feed”, or “channel” and can be read using software called an “RSS reader”, “feed reader”, or “aggregator”, which can be message-based, desktop-based, or mobile-device-based. Generally speaking, RSS feed can be subscribed by specifying a universal resource locator (URL) of the RSS feed within the RSS reader.

A social network is a social structure (e.g., community) made of members (e.g., a person) connected by social relationships such as friendship, kinship, relationships of beliefs, knowledge, prestige, culture, etc. Members of a social network often share interests and activities relating to such social relationships. For example, individual computers linked electronically could form the basis of computer mediated social interaction and networking within a social network community. A social network service focuses on building online communities of people who share interests and/or activities, or who are interested in exploring the interests and activities of others. Most social network services are message based and provide a variety of ways (e.g., e-mail, instant messaging service, etc.) for users (or members) to interact socially via social network messages. Examples of computer mediated social network services include Facebook® (a registered trademark of Facebook, Inc., Palo Alto, Calif.), Myspace® (a registered trademark of Myspace, Inc., Beverly Hills, Calif.), Twitter® (a registered trademark of Twitter, Inc., San Francisco, Calif.), LinkedIn® (a registered trademark of LinkedIN, Ltd., Mountain View, Calif.), etc. Certain social network services provide application programming interface allowing programmatic access to retrieve social network messages.

SPAM is the abuse of electronic messaging systems to send unsolicited bulk messages indiscriminately. For example, SPAM may be sent using email, instant messaging (IM), simple messaging service (SMS), newsgroup and forum, etc. A website may provide an option for a user to receive promotional messages by voluntarily providing an email address, IM name, phone number, etc. Depending on the privacy policy of such website, information provided may attract unsolicited promotional messages from sources other than such website. In addition, membership in a newsgroup or forum may also attract unsolicited promotional messages.

### SUMMARY

In general, in one aspect, the invention relates to a method to send a promotional offer from a business entity. The method steps include obtaining a profile of the business entity from a financial management application (FMA) executing on a central processing unit (CPU) and configured to manage operations of the business entity, analyzing a plurality of messages from a message source based on a pre-determined criterion to identify a keyword, qualifying the keyword to generate a qualified keyword with a keyword rating, wherein the keyword rating represents how relevant the keyword is to the business entity based on the profile of the business entity, searching for the qualified keyword in the promotional offer among a plurality of promotional offers in a library to generate a match between the qualified keyword and the promotional offer, adjusting a score of the promotional offer, in response to generating the match, based on the keyword rating, and sending the promotional offer to a consumer based on the score.

In general, in one aspect, the invention relates to a method to receive a promotional offer from a business entity. The method steps include providing contact information to the business entity, accepting an offer to join a recipient list, and receiving, in response to accepting the offer, the promotional offer based on the contact information, wherein the promotional offer is sent from the business entity based on obtaining a profile of the business entity from a financial management application (FMA) executing on a central processing unit (CPU) and configured to manage operations of the business entity, analyzing a plurality of messages from a message source based on a pre-determined criterion to identify a keyword, qualifying the keyword to generate a qualified keyword with a keyword rating, wherein the keyword rating represents how relevant the keyword is to the business entity based on the profile of the business entity, searching for the qualified keyword in the promotional offer among a plurality of promotional offers in a library to generate a match between the qualified keyword and the promotional offer, adjusting a score of the promotional offer, in response to generating the match, based on the keyword rating, and sending the promotional offer to members of the recipient list based on the score.

In general, in one aspect, the invention relates to a system for sending a promotional offer from a business entity. The system includes a financial management application (FMA) configured to manage operations of the business entity, a repository storing a plurality of promotional offers, a user module configured to obtain a profile of the business entity from the FMA, a message analyzer configured to analyze a plurality of messages from a message source based on a pre-determined criterion to identify a keyword, a keyword qualifier configured to qualify the keyword to generate a qualified keyword with a keyword rating, wherein the keyword rating represents how relevant the keyword is to the business entity based on the profile of the business entity, a promotional offer analyzer configured to search for the qualified keyword in the promotional offer among the plurality of promotional offers to generate a match between the qualified keyword and the promotional offer, and adjust a score of the promotional offer, in response to generating the match, based on the keyword rating, and an advertizing module configured to send the promotional offer to a consumer based on the score.

In general, in one aspect, the invention relates to a computer readable medium storing instructions executable by a computer to send a promotional offer from a business entity. The instructions, when executed by the computer, include functionality for obtaining a profile of the business entity from a financial management application (FMA) executing on a central processing unit (CPU) and configured to manage operations of the business entityn analyzing a plurality of messages from a message source based on a pre-determined criterion to identify a keyword, qualifying the keyword to generate a qualified keyword with a keyword rating, wherein the keyword rating represents how relevant the keyword is to the business entity based on the profile of the business entity, searching for the qualified keyword in the promotional offer among a plurality of promotional offers in a library to generate a match between the qualified keyword and the promotional offer, adjusting a score of the promotional offer, in response to generating the match, based on the keyword rating, and sending the promotional offer to a consumer based on the score.

Other aspects of the invention will be apparent from the following description and the appended claims.

### BRIEF DESCRIPTION OF DRAWINGS

FIG. 1 depicts a schematic block diagram of a system in accordance with one or more embodiments of the invention.

FIGS. 2A and 2B depict flowcharts of methods in accordance with one or more embodiments of the invention.

FIGS. 3A and 3B depict screen shots of an example application in accordance with one or more embodiments of the invention.

FIG. 4 depicts a computer system in accordance with one or more embodiments of the invention.

### DETAILED DESCRIPTION

Specific embodiments of the invention will now be described in detail with reference to the accompanying Figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relates to a system and method to send promotional offers from a business entity. In particular, the business entity receives suggestions on which promotional offers to send for a current promotion campaign. Specifically, online information or messages from one or more sources are analyzed to find keywords occurring in large numbers reflecting a trend during a current time period that are relevant to the business entity. For example, the trend may indicate what people are discussing in general and specifically what other business entities may be promoting. In addition, a rating is assigned to each of the found keywords based on a relevancy measure to the business entity. For example, the keyword that is more relevant to the activities of the business entity may be assigned a higher rating. These newly found keywords with assigned ratings are presented as marketing intelligence to a user who may be a sole proprietor and/or small business owner (SBO) of the business entity or an individual associated with the business entity. Accordingly, the user may develop appropriate promotional offers based on such marketing intelligence to address the current trend for sending to consumers from the business entity.

Further, promotional offers used by the business entity in previous promotional activities are stored in a library and displayed according to assigned scores for the user to select for the current promotion. For example, the initial scores may be based on when each promotional offer is most recently sent or a success level associated with each promotional offer in previous promotional activities. When new keywords are found reflecting the current trend, the scores of those promotional offers containing such new keywords are adjusted based on the keyword ratings. Accordingly, the order in which the promotional offers in the library are displayed to the user for selection is adjusted based on the new marketing intelligence.

In one or more embodiments of the invention, the business entity manages business operations using a computerized financial management application (FMA). In such embodiments, the relevancy measure for determining the keyword ratings may be based on a comparison, using various heuristics, between categories of the found keywords and profile information of the business entity available within the FMA.

For example, based on keywords found before or during school opening time, the user may be suggested to run promotional offers on school items such as school bags. Based on keywords found before or during a particular festival, related businesses such as sweater retailers may be suggested to run promotional offers on items related to the festival. In another example, opt-in promotion messages or SPAM promotion messages from other business entities in similar types of business may be used to extract keywords as marketing intelligence. In yet another example, the relevance measure for assigning keyword ratings may include consideration of the location of the business entity identified by a Geocode such as a postal zip code.

Accordingly, a promotional offer suggestion application of the present invention may present (e.g., by displaying) to the user a suggested list of promotional offers, ordered based on automatically generated marketing intelligence, from which the user can select (e.g., by clicking) a desired one to publish (i.e., send to consumers).

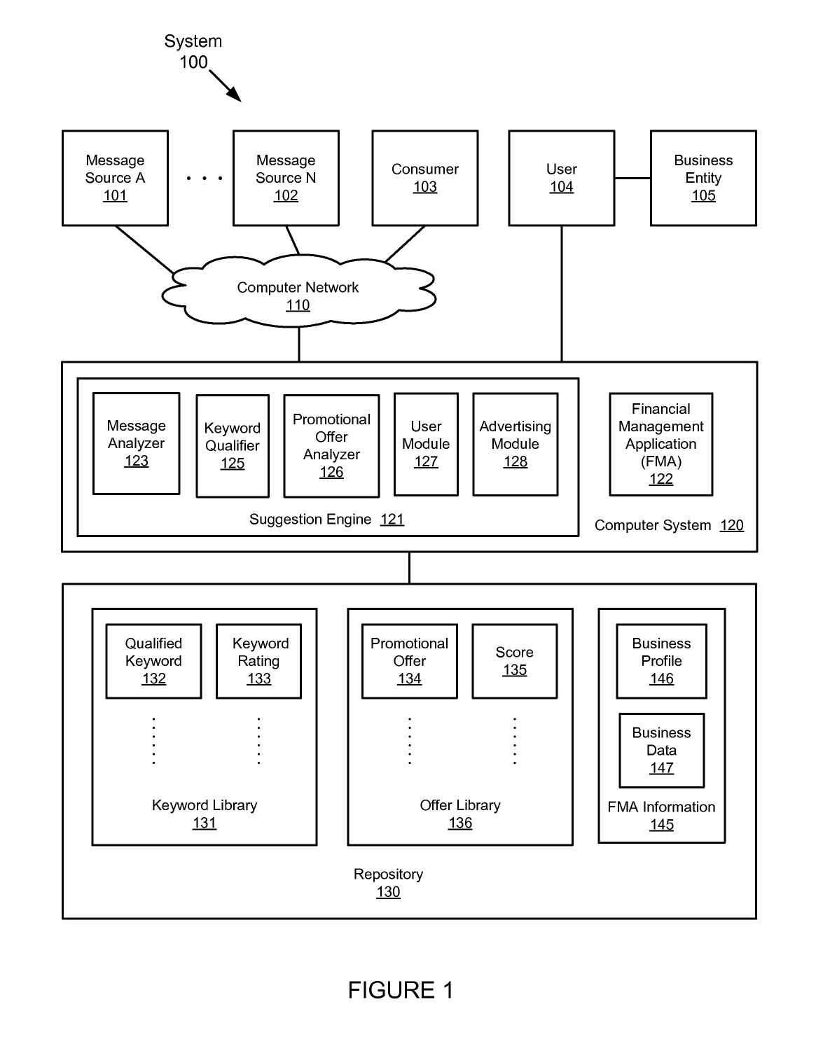

FIG. 1 depicts a schematic block diagram of a system (100) in accordance with one or more embodiments of the invention. In one or more embodiments of the invention, one or more of the modules and elements shown in FIG. 1 may be omitted, repeated, and/or substituted. Accordingly, embodiments of the invention should not be considered limited to the specific arrangements of modules shown in FIG. 1.

As shown in FIG. 1, the system (100) includes Message sources (e.g., Message source A (101), Message source N (102), etc.), consumer (103), and computer system (120), all of which are coupled via computer network (110). Further, the computer system (120) is installed with financial management application (FMA) (122) and suggestion engine (121) having message analyzer (123), keyword qualifier (125), promotional offer analyzer (126), user module (127), and advertising module (128). Furthermore, the system (100) includes repository (130) coupled to the computer system (120) and storing keyword library (131) including one or more qualified keyword (e.g., qualified keyword (132)) and corresponding keyword rating (e.g., keyword rating (133)), offer library (136) including promotional offers (e.g., promotional offers (134)) and corresponding scores (e.g., score (135)), and FMA information (145) including business profile (146) and business data (147). In addition, the system (100) includes user (104) associated with business entity (105) of which business operations are managed using the FMA (122). In particular, the network (110) may be the Internet, the message sources (e.g., message source A (101), message source N (102), etc.) may be part of the world wide web, and the consumer (103) may include a computing device (not shown) for accessing emails and text messages via the computer network (110).

In one or more embodiments of the invention, a message source (e.g., message source A (101), message source N (102), etc.) may be any of a social network website, a Rich Site Summary (RSS) server, a marketing entity, or other types of websites. In one or more embodiments, the message source (e.g., message source A (101), message source N (102), etc.) includes an application programming interface (API) (not shown) allowing message contents to be accessed via the computer network (110). For example, message contents may include social network messages, RSS feeds, opt-in or un-solicited marketing messages, webpage contents, etc.

Generally speaking, the consumer (103) may be an individual or other entity that is a potential customer for products or services provided by the business entity (105) while the user (104) may be a sole proprietor and/or small business owner (SBO) of the business entity (105) or an individual associated with the business entity (105).

In one or more embodiments of the invention, the FMA (122) is configured to manage operations of the business entity (105) based on the FMA information (145) stored in the repository (130). For example, the FMA (122) may be an accounting software, an order entry and inventory control software, or other types of business financial management software. The business profile (146) may include information describing a business type, target market, target customer, etc. of the business entity (105). The business data (147) may include transaction records (not shown) related to customer purchases. In one or more embodiments, such transaction records may be correlated with promotional offers used to stimulate customer purchases. In one or more embodiments, such correlation may be included as part of the business data (147).

In one or more embodiments of the invention, the suggestion engine (121) or a portion thereof may be a stand alone software in communication with the FMA (122), a user installable add-on module of the FMA (122), an optional functional module within the FMA (122), or a standard feature built-in within the FMA (122). In one or more embodiments of the invention, the suggestion engine (121) may be provided by a provider of the FMA (122) or by a third party separate from the provider of the FMA (122).

In one or more embodiments of the invention, the computer system (120) may be operated by the user (104) for accessing functionalities of the FMA (122) and the suggestions engine (121). In one or more embodiments, the computer system (120) may be operated by an application service provider from which the user (104) may access the functionalities of the FMA (122) and the suggestions engine (121).

In one or more embodiments of the invention, the suggestion engine (121) includes the user module (127) that is configured to obtain a profile (e.g., business profile (146)) of the business entity (105) from the FMA (122). For example, the business profile (146) may include a type or a category of business, customer, and/or promotional events in which the business entity (105) is engaged on an on-going basis as well as a geolocation and/or affiliation of the business entity (105). In addition, the user module (127) is configured to present a user interface (e.g., a graphical user interface) for the user (104) to receive a suggested list of promotional offers. In one or more embodiments, the suggested list of promotional offers may be generated and provided automatically, for example on a periodic basis (e.g., hourly, daily, weekly, monthly, quarterly, annually, etc.) or in response to events automatically identified by the suggestion engine (121). In one or more embodiments, the suggested list of promotional offers may be generated and provided in response to a request from the user (104) in which case the user module (127) is configured to receive such request from the user (104).

In one or more embodiments of the invention, the suggestion engine (121) includes the message analyzer (123) that is configured to obtain messages from a message source (e.g., message source A (101), message source N (102), etc.) for analysis to identify a keyword (not shown).

In one or more embodiments, the message source A (101) is a website and the message analyzer (123) is configured to obtain messages by website crawling. In one or more embodiments, the message source A (101) is a social network website and the message analyzer (123) is configured to obtain messages using an application programming interface of the social network website. In one or more embodiments, the message source A (101) is a Rich Site Summary (RSS) server and the message analyzer (123) is configured to obtain messages by subscribing to the RSS feed. In one or more embodiments, the message source A (101) is a marketing entity. In one of such embodiments, the message analyzer (123) is configured to provide contact information to the marketing entity, accept an offer to join a recipient list of the marketing entity, and obtain messages in an opt-in manner, in response to accepting the offer, from the marketing entity based on the contact information. In another one of such embodiments, the message analyzer (123) is configured to obtain messages by receiving SPAM messages from the marketing entity.

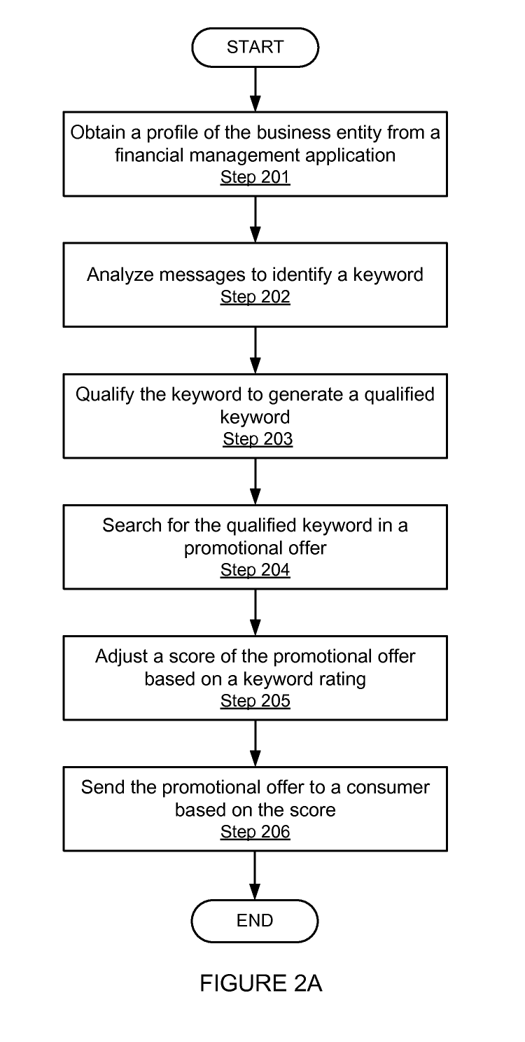

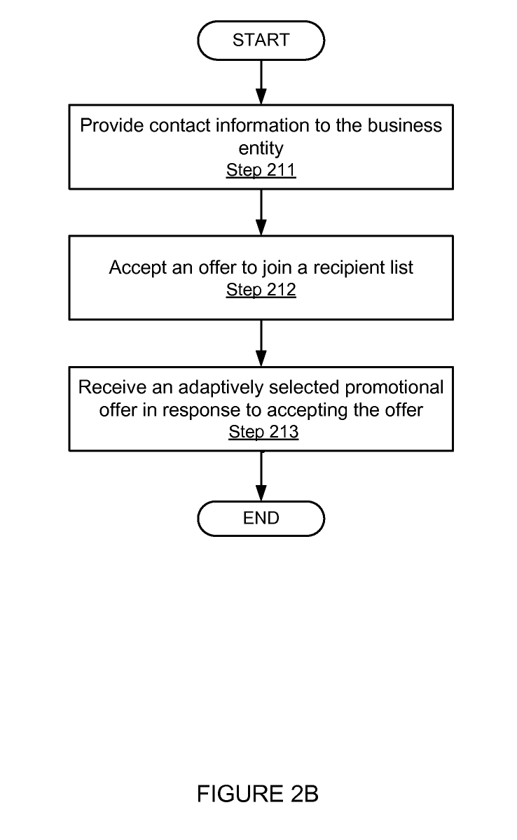

In one or more embodiments of the invention, the message analyzer (123) is configured to analyze the obtained messages based on computer heuristics to identify the keyword (not shown). For example, the keyword may be identified by detecting an increase in occurrences of a particular word in the obtained messages during a current time period as compared to a baseline established during a prior time period where such increase reflects a popularity trend of using such words in messages. More details of such example heuristics are described in reference to FIG. 2 below.

In one or more embodiments of the invention, the suggestion engine (121) includes the keyword qualifier (125) that is configured to qualify the keyword (not shown) to generate a qualified keyword (e.g., qualified keyword (132)) with a corresponding keyword rating (e.g., keyword rating (133)). In one or more embodiments, the keyword rating (133) represents how relevant the qualified keyword (132) is to the business entity (105). For example, an identified keyword (not shown) that is not related to activities of the business entity (105) may be assigned a zero rating and not considered as a qualified keyword (e.g., qualified keyword (132)) while another identified keyword (not shown) that is highly related to activities of the business entity (105) may be assigned a high rating (e.g., a number grade, a percentage grade, a letter grade, etc.) and considered as a qualified keyword (e.g., qualified keyword (132)). In one or more embodiments, the keyword qualifier (125) is configured to determine the keyword rating (133) by comparing the qualified keyword (132) to the business profile (146) using computer heuristics such as semantic analysis and topic discovery heuristics.

In one or more embodiments of the invention, the keyword library (131) includes a collection of pre-determined qualified keywords (e.g., qualified keyword (132)) and corresponding pre-determined keyword ratings (e.g., keyword rating (133)). In one or more embodiments, the keyword library (131) may be constructed using computer heuristics such as semantic analysis and topic discovery heuristics based on the profile of the business entity. In one or more embodiments, the user module (127) is configured to present an identified keyword (e.g., qualified keyword (132)) from the message analyzer (123) to the user (104) and obtain a manually assigned keyword rating (e.g., keyword rating (133)). For example, the user (104) may assign the keyword rating (133) by manually considering how relevant the qualified keyword (132) is to the business entity (105). In such embodiments, each time the identified keyword (e.g., qualified keyword (132)) is presented to the user (104), it is stored in the keyword library (131) along with the manually assigned keyword rating (e.g., keyword rating (133)). In this manner, the keyword library (131) may be constructed and expanded over time. Furthermore, in such embodiments, the keyword qualifier (125) is configured to compare a newly identified keyword (not shown) to each of the keywords (e.g., qualified keyword (132)) in the keyword library (131) to find a match thus looking up the corresponding keyword rating (e.g., keyword rating (133)). If no match can be found, then the newly identified keyword (not shown) is presented to the user (104) via the user module (127) to obtain a newly assigned keyword rating (not shown) and add to the keyword library (131).

In one or more embodiments of the invention, the offer library (136) includes a collection of promotional offers (e.g., promotional offer (134)) and corresponding scores (e.g., score (135)). For example, the promotional offers (e.g., promotional offer (134)) may include a discount term, a coupon, a sweepstake, a contest, a product sample, a rebate, a tie-in term, a trade-in term, etc. In one or more embodiments, the promotional offers (e.g., promotional offer (134)) and corresponding scores (e.g., score (135)) are pre-determined. In one or more embodiments, the promotional offers (e.g., promotional offer (134)) are collected from previous promotion campaigns conducted by the business entity (105). In one or more embodiments, the scores (e.g., score (135)) corresponding to the promotional offers (e.g., promotional offer (134)) are determined based on a pre-determined criterion. For example, the score (135) may be determined based on how recent the promotional offer (134) has been used in a promotion campaign. Specifically, the more recently used promotional offers (e.g., promotional offer (134)) may be assigned a higher score (e.g., score (135) such as a number score, a percentage score, a letter score, etc.) while a promotional offer (e.g., promotional offer (134)) that has not been used for a long time may be assigned a low score (e.g., score (135). In another example, the score (135) may be determined based on how successful the promotional offer (134) has been when used in a previous promotion campaign. Specifically, the more successful the promotional offers (e.g., promotional offer (134)) are, the higher the scores (e.g., score (135) such as a number score, a percentage score, a letter score, etc.) are assigned while a promotional offer (e.g., promotional offer (134)) that has not been successful may be assigned a low score (e.g., score (135)). In one or more embodiments, the success of promotional offers (e.g., promotional offer (134)) is determined based on stimulated customer purchases deducted from the business data (147). For example, transactions in the business data (147) may be correlated to promotion campaigns to determine stimulated customer purchases and the level of success of promotional offers used therein.

In one or more embodiments of the invention, the suggestion engine (121) includes a promotional offer analyzer (126) that is configured to adjust a score (e.g., score (135)) of a promotional offer (e.g., promotional offer (134)) based on presence of newly identified qualified keywords (e.g., qualified keyword (132)) in the promotional offer (e.g., promotional offer (134)). In one or more embodiments, the adjustment of the score (135) of the promotional offer (134) containing a newly identified qualified keyword (132) is based on the keyword rating (133). For example, the higher the keyword rating (133), the larger the amount of the adjustment is to increase the score (135). Conversely, the score (135) may be increased minimally for lower keyword rating (133) or even decreased if the keyword rating (133) is less than a pre-determined threshold.

In one or more embodiments of the invention, the suggestion engine (121) includes the advertising module (128) that is configured to send promotional offers (e.g., promotional offer (134)) to the consumer (103) based on the score (e.g., score (135)). For example, the promotional offer (134) may be sent if the score (135) is deemed sufficiently high indicating that the promotional offer (134) may be successful considering the marketing intelligence represented by newly identified qualified keywords (e.g., qualified keyword (132)) contained in the promotional offer (134). For example, the promotional offer (134) may be sent if the score (135) exceeds a pre-determined threshold. In one or more embodiments, the promotional offer (134) may be sent as a direct mail, an e-mail, a text message, a telemarketing message, etc.

In one or more embodiments, the promotional offers (e.g., promotional offer (134)) in the offer library (136) are presented to the user (104) in a sequence according to corresponding scores (e.g., score (135)) for selection to be used in a promotion campaign. For example, the promotional offer (134) may be selected by the user (104) based on its position in the sequence. Further, the sequence may only include (i) a fixed number of promotional offers (e.g., promotional offer (134)) with highest scores or (ii) those promotional offers (e.g., promotional offer (134)) with corresponding scores (e.g., score (135)) exceeding a pre-determined threshold. In one or more embodiments, the user module (127) is configured to receive a selected promotional offer (e.g., promotional offer (134)) from the user (104) and provide it to the advertising module (128) for use in the promotion campaign.

FIGS. 2A and 2B depict flowcharts of methods in accordance with one or more embodiments of the invention. In one or more embodiments of the invention, one or more of the steps shown in FIGS. 2A and 2B may be omitted, repeated, and/or performed in a different order. Accordingly, embodiments of the invention should not be considered limited to the specific arrangements of steps shown in FIGS. 2A and 2B.

The method depicted in FIG. 2A is from a system perspective and may be practiced using system (100) described with respect to FIG. 1 above. Initially in Step 201, a profile of a business entity is obtained from a financial management application (FMA) that is configured to manage operations of the business entity. For example, the FMA may be an accounting software, an order entry and inventory control software, or other types of business financial management software. The business profile may include information describing a business type, target market, target customer, etc. of the business entity, such as a retailer.

In Step 202, messages from a message source are analyzed based on a pre-determined criterion to identify a keyword. For example, the message source may be any of a social network website, a Rich Site Summary (RSS) server, a marketing entity, or other types of websites while message contents may include social network messages, RSS feeds, opt-in or un-solicited marketing messages, webpage contents, etc. In one or more embodiments of the invention, such messages may be obtained for analysis by accessing an application programming interface of the social network website, subscribing to a RSS feed, accepting an offer to join a recipient list of the marketing entity, receiving SPAM messages, or website crawling.

In one or more embodiments of the invention, the obtained messages are analyzed based on computer heuristics to identify the keyword. For example, the keyword may be identified by detecting an increase in occurrences of a particular word in the obtained messages during a current time period as compared to a baseline where such increase reflects a popularity trend of such word. In one or more embodiments, the steps of detecting an increase in occurrences of a particular word in the obtained messages include (i) tallying word counts of a set of words in a portion of the messages dated within a prior date range to generate a baseline tally; (ii) tallying word counts of another set of words in another portion of the messages dated within a current date range to generate a current tally; and (iii) comparing the current tally to the baseline tally to generate a difference. Specifically, a particular word is identified as a keyword if a count of such word in the current tally exceeds a count of the same word in the baseline tally by more than a pre-determined threshold.

In Step 203, the keyword is qualified to generate a qualified keyword with a keyword rating where the keyword rating represents how relevant the keyword is to the business entity based on the profile of the business entity. For example, an identified keyword that is not related to activities of the business entity will be assigned a zero rating and not considered as a qualified keyword while another identified keyword that is highly related to activities of the business entity will be assigned a high rating (e.g., a number, a percentage, a letter grade, etc.) and considered as a qualified keyword. In one or more embodiments, the keyword rating is determined by comparing the qualified keyword to the business profile obtained from the FMA using computer heuristics such as semantic analysis and topic discovery heuristics.

In one or more embodiments of the invention, pre-determined qualified keywords may be collected and stored in a keyword library with corresponding pre-determined keyword ratings. In one or more embodiments, the keyword library may be constructed using computer heuristics such as semantic analysis and topic discovery heuristics based on the profile of the business entity. In one or more embodiments, the keyword ratings may be manually assigned. For example, the user may assign the keyword rating by manually considering how relevant the keyword is to the business entity. In such embodiments, as a keyword is identified from the obtained messages, it is presented to the user for manually assigning a keyword rating and stored in the keyword library. In this manner, the keyword library may be constructed and expanded over time. Furthermore, in such embodiments, a newly identified keyword is compared to each of the keywords in the keyword library to find a match thus looking up the corresponding keyword rating. If no match can be found, then the newly identified keyword is presented to the user to obtain a newly assigned keyword rating for adding to the keyword library.

In one or more embodiments of the invention, a collection of promotional offers (e.g., promotional offers used in previous promotion campaigns of the business entity) and corresponding scores (e.g., number scores, percentage scores, letter scores, etc.) are stored in an offer library. For example, the promotional offers may include a discount term, a coupon, a sweepstake, a contest, a product sample, a rebate, a tie-in term, a trade-in term, etc. In one or more embodiments, a score may be determined based on how recent the promotional offer has been used in a promotion campaign. Specifically, the more recently used promotional offers may be assigned higher scores while a promotional offer that has not been used for a long time may be assigned a low score. In another example, the score may be determined based on how successful the promotional offer has been when used in a previous promotion campaign. Specifically, the more successful the promotional offers are, the higher the scores are assigned while a promotional offer that has not been successful may be assigned a low score. In one or more embodiments, the success of promotional offers is determined based on stimulated customer purchases deducted from the business data within the FMA. For example, transactions in the business data may be correlated to promotion campaign to deduct stimulated customer purchases.

In Step 204, a promotional offer in the offer library is searched for the presence of a qualified keyword. In one or more embodiments of the invention, each promotional offer in the offer library is searched for the presence of any qualified keyword in the keyword library. If any qualified keyword is present in the searched promotional offer, the score of the promotional offer containing the qualified keyword is adjusted based on the keyword rating of the contained qualified keyword. (Step 204). For example, if the promotional offer contains a qualified keyword with high rating indicating that the contained keyword is highly relevant to the business entity, the score is adjusted higher accordingly. If the promotional offer (i) contains a qualified keyword with low rating indicating that the contained keyword is minimally relevant to the business entity or (ii) does not contain any qualified keyword, the score is accordingly adjusted minimally or even decreased.

In Step 206, a promotional offer is sent to a consumer based on the score. In one or more embodiments of the invention, the promotional offer is selected from the promotional offer library based on the score for sending to the consumer. For example, promotional offers in the offer library may be presented to the user for selecting the one to be sent. In one or more embodiments, promotional offers in the offer library may be presented to a user for selection in a sequence according to corresponding scores of the promotional offers. For example, the sequence may include only a fixed number of promotional offers with highest scores or only those promotional offers with corresponding scores exceeding a pre-determined threshold. In one or more embodiments, the user selects the promotional offer based on a position of the promotional offer in the sequence.

The method depicted in FIG. 2B is from a user perspective and may be practiced using system (100) described with respect to FIG. 1 above. Initially in Step 211 of FIG. 2B, contact information of the user is provided to the business entity. For example, the contact information may be provided by the user when signing up to create an account, during a marketing survey, requesting information, etc.

In Step 212, the user accepts an offer from the business entity or other marketing entity affiliated with the business entity to join a recipient list for receiving information such as product or service information, promotional information, etc. For example, the recipient list may be a mailing list, an email list, a newsletter distribution list, or other types of marketing distribution lists.

In Step 213, an adaptively selected promotional offer is received by the user based on the contact information in response to the user accepting the offer. In one or more embodiments of the invention, the adaptively selected promotional offer is selected by the business entity for sending to the user using the method steps described in reference to FIG. 1A above.

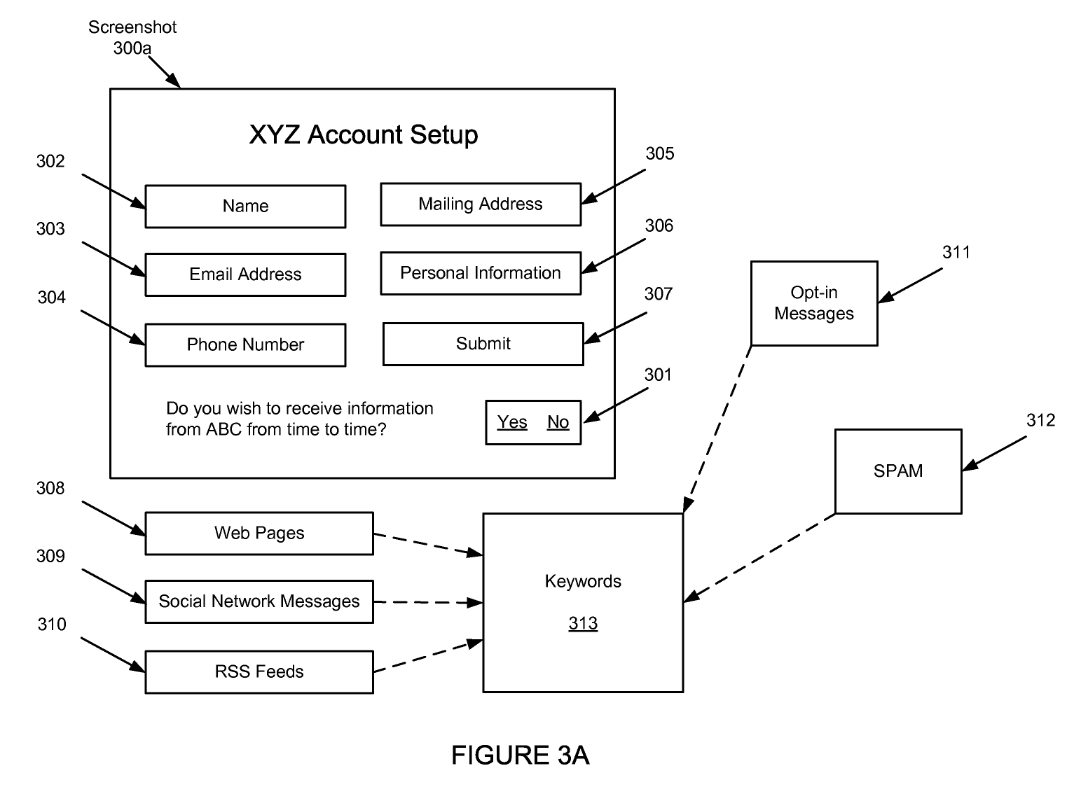

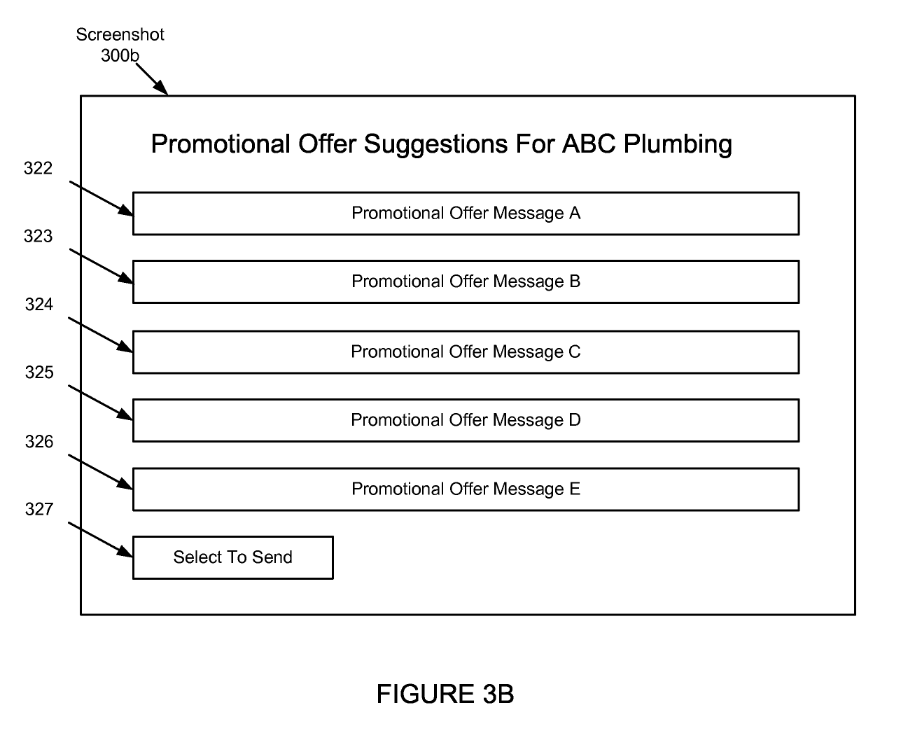

FIGS. 3A and 3B depict screen shots of an application example in accordance with one or more embodiments of the invention. This example application may be practiced using the system (100) of FIG. 1 and based on the methods described with respect to FIGS. 2A and 2B above. The example depicted in FIGS. 3A and 3B may be a small business “ABC Plumbing” using a financial management application “DEF Manager” to manage its business activities. In this example, the small business uses a stand alone application “GHI marketing intelligence collector” to gather marketing intelligence while the “DEF Manager” includes functionalities to organize promotional offers for marketing promotion campaigns. For example, “DEF Manager” maintains a list of promotional offers tagged with scores based on how recent each promotional offer was last used and/or other measures representing efficacy of each of the promotional offers.

As described above in reference to FIGS. 2A and 2B above, “GHI marketing intelligence collector” gathers marketing intelligence that is relevant to “ABC Plumbing” by (i) retrieving a business profile from “DEF Manager” that describes “ABC Plumbing” as a small business engaged in plumbing repair service business targeting homeowners in a city named “JKL city” and (ii) gathering popular keywords related to the business profile of “ABC Plumbing” that are increasingly found in current up-to-date messages collected from multiple information sources such as web pages, social networking messages, RSS feeds, opt-in marketing information, SPAMs, etc. For example, the opt-in marketing information and SPAMs may be found in the format of emails, instant messaging messages, mobile phone messages, social network messages, Internet forum postings, blog postings, faxes, etc. “GHI marketing intelligence collector” is configured with the functionality to acquire and expand additional information sources for “ABC Plumbing” as illustrated in FIG. 3A below.

As shown in FIG. 3A, screenshot (300a) depicts that “GHI marketing intelligence collector” accesses an account setup webpage of “XYZ company” to set up an account. Such access may be performed by automatic websites crawling or by manual activation. While the account at “XYZ company” may be a customer account mainly intended for real customers of “XYZ company,” the purpose for setting up such account in this example is to join the information distribution list of “XYZ company,” which turns out to be a national chain of household repair service company also doing business in “JKL city”. During the account set up process, the data entry fields (302)-(306) are populated by “GHI marketing intelligence collector” with appropriate information. In particular, the email address field (303) is populated using a dedicated email address reserved for collecting current up-to-date messages related to household repair industry. Further, the personal information field (306) may include instant messaging ID, mobile phone number, social network ID, Internet forum ID, blog ID, fax number, etc. Once “Yes” is clicked in opt-in field (301) and submit button (307) is clicked, “GHI marketing intelligence collector” starts to collect various information (e.g., opt-in messages (311)) “XYZ company” sends to its customers for marketing promotions in multiple formats described above. In addition, the email address (303) and other personal information (306) submitted this way may attract SPAM (312) from other business/marketing entities depending on the privacy policy of “XYZ company” and enforcement thereof. Furthermore, “GHI marketing intelligence collector” collects information by crawling web pages (308), acquiring social network messages (309) via application programming interfaces of various social network websites, and subscribing to RSS feeds (310). In this fashion, “GHI marketing intelligence collector” collects increasingly used keywords (313) as marketing intelligence relevant to household repair industry using method steps (201)-(203) and (211)-(212) described in reference to FIGS. 2A and 2B above.

Given a collection of such marketing intelligence from “GHI marketing intelligence collector” relevant to the business profile of “ABC Plumbing”, “DEF manager” retrieves promotional offers, used by “ABC Plumbing” in previous marketing promotion campaigns, and adjusts tagged scores based on whether any increasingly used keywords in current market trend is contained therein. As shown in FIG. 3B, screenshot (300b) depicts top five promotional offers (322)-(326) selected according to the adjusted scores that are presented to “ABC Plumbing” in a suggestion page from which one or more suggested promotional offers may be selected by “ABC Plumbing” for sending (327) to its client base.

Although in the example depicted above, the “GHI marketing intelligence collector” and “DEF manager” are owned and operated by “ABC Plumbing”, numerous other configurations are also possible. For example, the “GHI marketing intelligence collector” may be operated by a third party marketing company that develops multiple information sources in a leveraged manner for all its clients such as “ABC Plumbing” company. Further, the functionality of organizing promotional offers and adjusting tagged scores may be separated from “DEF manager” and integrated within “GHI marketing intelligence collector”.

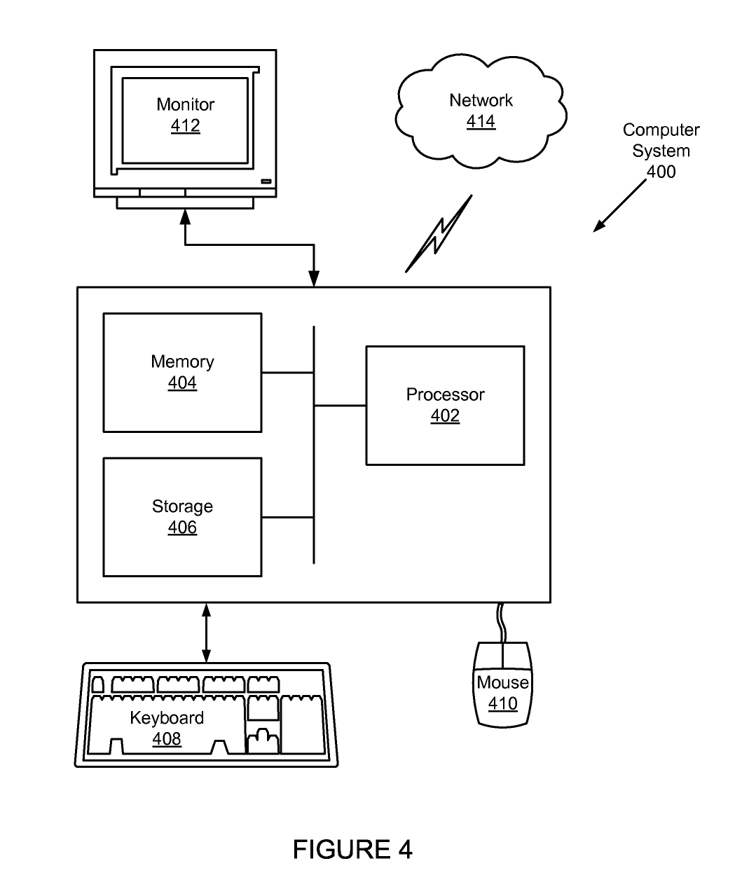

Embodiments of the invention may be implemented on virtually any type of computer regardless of the platform being used. For example, as shown in FIG. 4, a computer system (400) includes one or more processor(s) (402) such as a central processing unit (CPU), integrated circuit, etc., associated memory (404) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). The computer system (400) may also include input means, such as a keyboard (408), a mouse (410), or a microphone (not shown). Further, the computer system (400) may include output means, such as a monitor ((412) (e.g., a liquid crystal display (LCD), a plasma display, or cathode ray tube (CRT) monitor). The computer system (400) may be connected to a network (414) (e.g., a local area network (LAN), a wide area network (WAN) such as the Internet, or any other similar type of network)) with wired and/or wireless segments via a network interface connection (not shown). Those skilled in the art will appreciate that many different types of computer systems exist, and the aforementioned input and output means may take other forms. Generally speaking, the computer system (400) includes at least the minimal processing, input, and/or output means necessary to practice embodiments of the invention.

Further, those skilled in the art will appreciate that one or more elements of the aforementioned computer system (400) may be located at a remote location and connected to the other elements over a network. Further, embodiments of the invention may be implemented on a distributed system having a plurality of nodes, where each portion of the invention (e.g., various elements of the computer system (120), the repository (130), etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions for performing embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to send a promotional offer from a business entity, comprising:
obtaining a profile of the business entity from a financial management application (FMA) executing on a central processing unit (CPU) and configured to manage operations of the business entity;
analyzing a plurality of messages from a message source based on a pre-determined criterion to identify a keyword;
qualifying the keyword to generate a qualified keyword with a keyword rating, wherein the keyword rating represents how relevant the keyword is to the business entity based on the profile of the business entity;
searching for the qualified keyword in the promotional offer among a plurality of promotional offers in a library to generate a match between the qualified keyword and the promotional offer;
adjusting a score of the promotional offer, in response to generating the match, based on the keyword rating; and
sending the promotional offer to a consumer based on the score.

2. The method of claim 1, wherein analyzing the plurality of messages from the message source based on the pre-determined criterion to identify the keyword comprises:
tallying word counts of a first plurality of words in a first portion of the plurality of messages dated within a prior date range to generate a first tally;
tallying word counts of a second plurality of words in a second portion of the plurality of messages dated within a current date range to generate a second tally;
comparing the first and second tallies to generate a difference; and
identifying the keyword in response to a count of the keyword in the second tally exceeding a count of the keyword in the first tally by more than a pre-determined threshold.

3. The method of claim 1, further comprising:
comparing the keyword to the profile of the business entity using computer heuristics to generate the keyword rating.

4. The method of claim 1, wherein the message source comprises a plurality of websites, the method further comprising:
obtaining the plurality of messages by website crawling.

5. The method of claim 1, wherein the message source comprises a social network website, the method further comprising:
obtaining the plurality of messages using an application programming interface of the social network website.

6. The method of claim 1, wherein the message source comprises a Rich Site Summary (RSS) server, the method further comprising:
obtaining the plurality of messages by subscribing to the RSS feed.

7. The method of claim 1, wherein the message source comprises a marketing entity, the method further comprising:
providing contact information to the marketing entity;
accepting an offer to join a recipient list of the marketing entity; and
receiving promotional messages from the marketing entity based on the contact information in response to accepting the offer,
wherein the plurality of messages comprises the received promotional messages.

8. The method of claim 1,
wherein the message source comprises a marketing entity, and
wherein the plurality of messages comprises a SPAM message from the marketing entity.

9. The method of claim 1,
wherein the promotional offer is sent as at least one selected from a group consisting of a direct mail, an e-mail, a text message, and a telemarketing message, and
wherein the promotional offer comprises at least one selected from a group consisting of a discount term, a coupon, a sweepstake, a contest, a product sample, a rebate, a tie-in term, and a trade-in term.

10. The method of claim 1, further comprising:
presenting the plurality of promotional offers to a user in a sequence according to a corresponding score of each of the promotional offers,
wherein the promotional offer is selected by the user for sending to the consumer based on a position of the promotional offer in the sequence.

11. A method to receive a promotional offer from a business entity, comprising:
providing contact information to the business entity;
accepting an offer to join a recipient list; and
receiving, in response to accepting the offer, the promotional offer based on the contact information, wherein the promotional offer is sent from the business entity based on:
obtaining a profile of the business entity from a financial management application (FMA) executing on a central processing unit (CPU) and configured to manage operations of the business entity,
analyzing a plurality of messages from a message source based on a pre-determined criterion to identify a keyword,
qualifying the keyword to generate a qualified keyword with a keyword rating, wherein the keyword rating represents how relevant the keyword is to the business entity based on the profile of the business entity,
searching for the qualified keyword in the promotional offer among a plurality of promotional offers in a library to generate a match between the qualified keyword and the promotional offer,
adjusting a score of the promotional offer, in response to generating the match, based on the keyword rating, and
sending the promotional offer to members of the recipient list based on the score.

12. A system for sending a promotional offer from a business entity, comprising:
a financial management application (FMA) executing on a central processing unit (CPU) and configured with functionality to manage operations of the business entity;
a repository storing a plurality of promotional offers;
a user module executing on a central processing unit (CPU) and configured with functionality to obtain a profile of the business entity from the FMA;
a message analyzer executing on a central processing unit (CPU) and configured with functionality to analyze a plurality of messages from a message source based on a pre-determined criterion to identify a keyword;
a keyword qualifier executing on a central processing unit (CPU) and configured with functionality to qualify the keyword to generate a qualified keyword with a keyword rating, wherein the keyword rating represents how relevant the keyword is to the business entity based on the profile of the business entity;
a promotional offer analyzer executing on a central processing unit (CPU) and configured with functionality to:
search for the qualified keyword in the promotional offer among the plurality of promotional offers to generate a match between the qualified keyword and the promotional offer, and
adjust a score of the promotional offer, in response to generating the match, based on the keyword rating; and
an advertizing module executing on a central processing unit (CPU) and configured with functionality to send the promotional offer to a consumer based on the score.

13. The system of claim 12, wherein analyzing the plurality of messages from the message source based on the pre-determined criterion to identify the keyword comprises:
tallying word counts of a first plurality of words in a first portion of the plurality of messages dated within a prior date range to generate a first tally, tallying word counts of a second plurality of words in a second portion of the plurality of messages dated within a current date range to generate a second tally,
comparing the first and second tallies to generate a difference, and
identifying the keyword in response to a count of the keyword in the second tally exceeding a count of the keyword in the first tally by more than a pre-determined threshold.

14. The system of claim 12, wherein qualifying the keyword comprises:
comparing the keyword to the profile of the business entity using computer heuristics to generate the keyword rating.

15. The system of claim 12, wherein the message source comprises a plurality of websites, the message analyzer further configured to:
obtain the plurality of messages by website crawling.

16. The system of claim 12, wherein the message source comprises a social network website, the message analyzer further configured to:
obtain the plurality of messages using an application programming interface of the social network website.

17. The system of claim 12, wherein the message source comprises a Rich Site Summary (RSS) server, the message analyzer further configured to:
obtain the plurality of messages by subscribing to the RSS feed.

18. The system of claim 12, wherein the message source comprises a marketing entity, the message analyzer further configured to:
provide contact information to the marketing entity,
accept an offer to join a recipient list of the marketing entity, and
receive promotional messages from the marketing entity based on the contact information in response to accepting the offer,
wherein the plurality of messages comprises the received promotional messages.

19. The system of claim 12,
wherein the message source comprises a marketing entity, and
wherein the plurality of messages comprises a SPAM message from the marketing entity.

20. The system of claim 12,
wherein the promotional offer is sent as at least one selected from a group consisting of a direct mail, an e-mail, a text message, and a telemarketing message, and
wherein the promotional offer comprises at least one selected from a group consisting of a discount term, a coupon, a sweepstake, a contest, a product sample, a rebate, a tie-in term, and a trade-in term.

21. The system of claim 12, the user module further configured to:
present the plurality of promotional offers to a user in a sequence according to a corresponding score of each of the promotional offers, and
receiving a selection of the promotional offer from the user for sending to the consumer,
wherein the promotional offer is selected by the user based on a position of the promotional offer in the sequence.

22. A computer readable medium embodying instructions executable by a computer to send a promotional offer from a business entity, the instructions, when executed by the computer, comprising functionality for:
obtaining a profile of the business entity from a financial management application (FMA) executing on a central processing unit (CPU) and configured to manage operations of the business entity;
analyzing a plurality of messages from a message source based on a pre-determined criterion to identify a keyword;
qualifying the keyword to generate a qualified keyword with a keyword rating, wherein the keyword rating represents how relevant the keyword is to the business entity based on the profile of the business entity;
searching for the qualified keyword in the promotional offer among a plurality of promotional offers in a library to generate a match between the qualified keyword and the promotional offer;
adjusting a score of the promotional offer, in response to generating the match, based on the keyword rating; and
sending the promotional offer to a consumer based on the score.

23. The computer readable medium of claim 22, the instructions, when executed by the computer, further comprising functionality for:
tallying word counts of a first plurality of words in a first portion of the plurality of messages dated within a prior date range to generate a first tally;
tallying word counts of a second plurality of words in a second portion of the plurality of messages dated within a current date range to generate a second tally;
comparing the first and second tallies to generate a difference; and
identifying the keyword in response to a count of the keyword in the second tally exceeding a count of the keyword in the first tally by more than a pre-determined threshold.

24. The computer readable medium of claim 22, the instructions, when executed by the computer, further comprising functionality for:
sending the promotional offer as at least one selected from a group consisting of a direct mail, an e-mail, a text message, and a telemarketing message,
wherein the promotional offer comprises at least one selected from a group consisting of a discount term, a coupon, a sweepstake, a contest, a product sample, a rebate, a tie-in term, and a trade-in term.
